(19) United States
(12) Patent Application Publication
(10) Pub. No.: US 2010/0195508 A1
(43) Pub. Date: Aug. 5, 2010

(54) Method for checking ring network redundancy

(75) Inventors: Ming-Huang Ling, Shing Tien City (TW); Ming-Chuang Chen, Shing Tien City (TW)

Correspondence Address: BACON & THOMAS, PLLC, 625 SLATERS LANE, FOURTH FLOOR, ALEXANDRIA, VA, 22314-1176, US

(73) Assignee: MOXA, INC., Shing Tien City (TW)

(21) Appl. No.: 12/320,809

(22) Filed: Feb. 5, 2009

(51) Int. Cl. H04L 12/26; H04L 12/28

(52) U.S. Cl. 370/248; 370/258

(57) ABSTRACT

A method for checking a ring network redundancy includes a first exchanger and a second exchanger. When the first exchanger is set as a master, the plurality of second exchangers serve as the ring members; the first exchanger has a connection port, which is set as blocking, and the rest of connection ports are set as forwarding. The plurality of second exchangers regularly detects the plurality of connection ports for any outstanding status occurred in the connection status. When an outstanding status occurred, the CF5 is transmitted to the first exchanger and the first exchanger converts the connection port into the forwarding status, and the CF4 is transmitted to the plurality of second exchangers in order to renew the Mac address table. The method of sending out CF through a plurality of ring members can reduce the risk of losing the CF due to overloading network or having too much single network equipments, and thereby increase the reliability of the ring network during the redundancy checking.

### BACKGROUND OF THE INVENTION

1. Field of the invention

The present invention relates to a method for checking a ring network redundancy. More particularly, to a method for checking a ring network redundancy comprising transmitting a control frame (CF) through a plurality of ring members to increase credibility of the ring network and restoring the ring network to function normally.

2. Description of Related Art

The computers are widely used everywhere along with the rapidly developed computer technology and internet. Communication between people has become more convenient; the network technology enables the communication between people without limits of border. The network technology not only provides convenience to the end users but also benefits the companies to be more economical and increase its productive efficiency. The present available networks are majorly wide area network (WAN) and local area network (LAN). The LAN is the network system used in a single smaller region, for example, a company, a manufacturing plant, an office or a campus, and Ethernet is the LAN technology widely used in the business nowadays. The transmission feature of the Ethernet includes topology of a star or a tree structure. The defect of the tree structure is when the node or the path breaks down, the networks that are already connected will be separated as two sub-networks, which are unable to communicate with each other.

Therefore, to solve the above disconnection problem of the Ethernet, a technology to build up a redundancy is required. Accordingly, the IEEE has a spanning tree protocol (STP) for the 802.1D, and if the larger structure built by the multiple Ethernet exchangers, such as the mesh, the partial connection in the network structure will temporarily stop receiving/transmitting information to cover a mesh connection into the tree connection. When the node or the path in the network breaks down, the STP will recalculate and restore the backup route for the partial connection while the information receiving/transmission is stopped to reactivate the information receiving/transmission, thus the whole network can be reconnected as one because the STP enables the Ethernet exchanger to achieve the redundancy function.

However, the present physical operation of the industrial control equipment requires a simplified ring network structure instead of building up a complicated mesh Ethernet structure. Because the topology is the STP built of the mesh structure, which takes a longer time for restoration after the disconnection and meet less expectation, the IEEE has 802.1W, rapid spanning tree protocol (RSTP) reduce the conversion time of the port state and the convergence time by increasing the alternate port or the backup port.

Because even any second if the time for the industrial control repair operator is very important, the conventional STP and the RSTP no longer meet the requirement for faster connection restoration of the network. The present solution is to use a part of connection from the ring network as the backup path which only allows the particular CF to forward, but the general information frame will be blocked. Accordingly, the information blast will occur while the loop cannot be formed in the network. To deal with this problem, the user may set up one exchanger as master to regularly send the CF to the ring network. The path functions normally when the master receives the CF previously sent; otherwise, the backup path will be activated when the CF does not return to the master. However, such check method has a defect of losing the test frame to cause misjudgment due to the network overload and too many network equipments. Such check method makes the master activate the backup path un-normally. Meanwhile, the loop will be in the ring network to cause the broadcast blast, which means the frame will be continuously transmitted in cycle after being received by the target device and the ring network will be in busy status and disabled to transmit the next frame. As described above, such conventional method of checking is less reliable. If this redundancy mechanism is applied in the ring network of the company for production and manufacturing, the risk of incapability to transmit and malfunction of machines will substantially affect the short term and long term profit.

On the other hand, to transmit the CF under the ring network structure usually takes the processor of one exchanger to receive the CF from the previous exchanger for transmitting to the next one. However, the transmission processed through the processor of the exchanger can cause the delay of a certain time. More exchangers in the ring network, the accumulated time delayed will affect speed of the connection restoration.

Therefore, how to solve the above defects has become the important issue for the suppliers in the field.

### SUMMARY OF THE INVENTION

An object of the present invention is to provide a method for checking a ring network redundancy.

According to an aspect of the present invention, possible error opportunity while the ring network executing the checking of redundancy is reduced to enable smooth transmission of the information or signals in the corporation ring network. The embodiment uses a plurality of ring network members to regularly detect connection status of a connection port, and fifth CF is transmitted to the master when the outstanding status occurred. When the master receives the fifth CF, the blocked connection port is connected to activate the backup path. Thus the ring network can be smoother and have less error while the plurality of ring network members transmits the fifth CF to the master. Besides, the ring network members may directly detect the connection status of the connection port through a physical layer for checking for occurrence of any outstanding status, the master can learn the connection status of the connection ports of the present ring network members to promptly restore the operation in the ring network.

According to another aspect of the present invention, the first and the second exchangers comprise an exchange module and a microprocessor. When the exchange module of the first exchanger or the second exchanger receives the CF through the connection port, the CF is not only will be transmitted to the microprocessor thereof for processing, but also transmitted to the next first exchanger or the second exchanger, therefore time for processing redundancy mechanism to promptly reactivate the backup path under the ring network structure with the plurality of exchanger may be effectively shortened.

### BRIEF DESCRIPTION OF THE DRAWING

For a more complete understanding of the present invention, reference will now be made to the following detailed description of preferred embodiments taken in conjunction with the following accompanying drawings.

FIG. 1 is an aspect of a method for checking a ring network redundancy according to a preferred embodiment of the present invention.

FIG. 2 is a flowchart of a ring master electing for a ring network redundancy checking according to an embodiment of the present invention.

FIG. 3 is a flowchart of a loop checking for a ring network redundancy checking according to an embodiment of the present invention.

FIG. 4 is an aspect of disconnecting the connection port for a ring network redundancy checking according to an embodiment of the present invention.

FIG. 5 is a flowchart of a redundancy mechanism for a ring network redundancy checking according to an embodiment of the present invention.

FIG. 6 is a block diagram of transmitting a CF for a ring network redundancy checking according to an embodiment of the present invention.

### DETAIL DESCRIPTION OF THE INVENTION

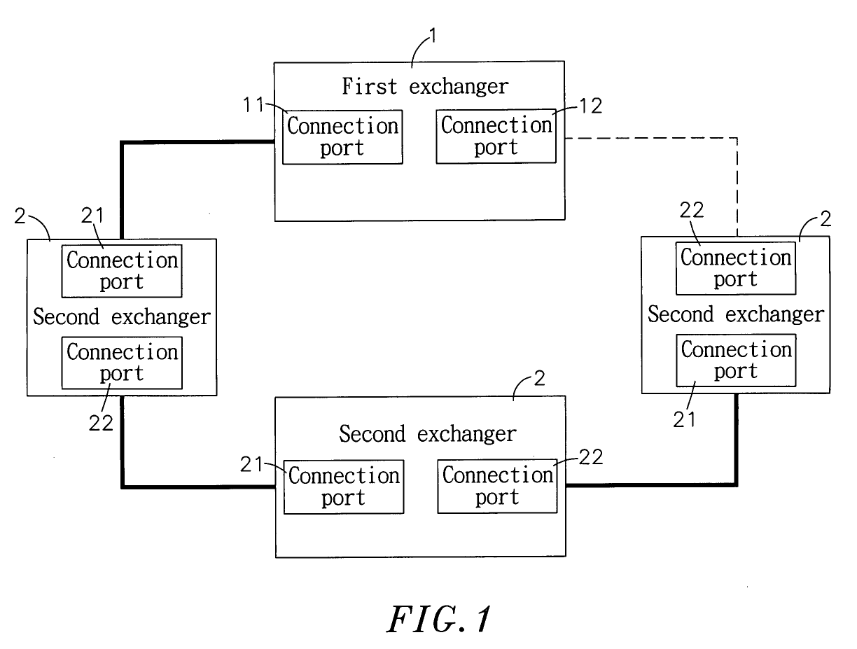

FIG. 1 is an aspect of a method for checking a ring network redundancy according to a preferred embodiment of the present invention. The ring network structure comprises a first exchanger 1 and a plurality of second exchangers 2.

The first exchanger 1 comprises at least two connection ports 11 and 12.

The plurality of second exchangers 2, and the first exchanger 1 are wired or wirelessly connected, wherein wired connection includes twisted pair cable and the fiber optic cable and the wireless connection includes IEEE 802.11 or 802.16. The second exchanger 2 comprises at least two connection ports 21 and 22.

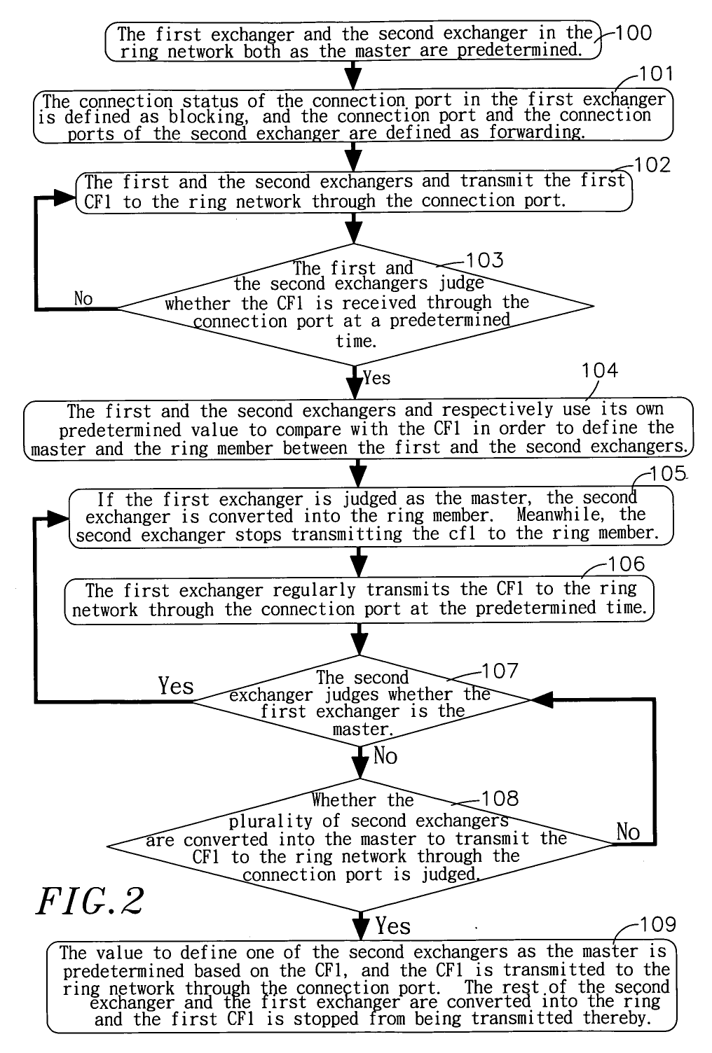

Referring to FIGS. 1 and 2, in a stable status, every ring network only exists in one master and can comprise a plurality of ring members at a time. Thus, the ring master election can define the master and the ring member between the first and the second exchangers 1 and 2. The procedure of the ring master election may be described as follows.

At step 100, the first exchanger 1 and the second exchanger 2 in the ring network both as the master are predetermined.

At step 101, the connection status of the connection port 12 in the first exchanger 1 is defined as blocking, and the connection port 11 of the first exchanger 1 and the connection ports 21 and 22 of the second exchanger 2 are defined as forwarding.

At step 102, the first and the second exchangers 1 and 2 transmit the first CF1 to the ring network through the connection port 11, 12, 21 or 22.

At step 103, the first and the second exchangers 1 and 2 judge whether the CF1 is received through the connection port 11, 12, 21 or 22 at a predetermined time, wherein if it judged that the CF1 is not received at the predetermined time, the procedure returns to step 102; otherwise the procedure proceeds to step 104.

At step 104, the first and the second exchangers 1 and 2 respectively use its own predetermined value to compare with the CF1 in order to define the master and the ring member between the first and the second exchangers 1 and 2.

At step 105, if the first exchanger 1 is judged as the master, the second exchanger 2 is converted into the ring member. Meanwhile, the second exchanger 2 stops transmitting the CF1 to the ring member.

At step 106, the first exchanger 1 regularly transmits the CF1 to the ring network through the connection port 11 or 12 at the predetermined time.

At step 107, the second exchanger 2 judges whether the first exchanger 1 is the master, wherein if it is judged that the first exchanger 1 is the master, the procedure returns to step 105, otherwise the procedure proceeds to step 108.

At step 108, whether the plurality of second exchangers 2 are converted into the master to transmit the CF1 to the ring network through the connection port 21 or 22 is judged, wherein if it is judged that the plurality of second exchangers 2 are not converted into the master to transmit the CF1 to the ring network through the connection port 21 or 22, the procedure returns to step 107, otherwise the procedure proceeds to step 109.

At step 109, the value to define one of the second exchangers 2 as the master is predetermined based on the CF1, and the CF1 is transmitted to the ring network through the connection port 21 or 22. The rest of the second exchanger 2 and the first exchanger 1 are converted into the ring members, and the first CF1 is stopped from being transmitted thereby.

According to the above depiction, the method for the second exchanger 2 judging the first exchanger 1 as non master is when no CF1 is received from the first exchanger 1 at a predetermined time, or the priority defined by the user has been changed. Thus, every second exchanger 2 will be converted into the master, and the first CF1 comprises the priority and the Mac. address. The predetermined value comprises the exchanger of its own priority and Mac. address thereof. The exchanger compares its own predetermined value with the received CF1 in order to determine whether the exchanger is the master or the ring member. Furthermore, the connection status of blocking is as the backup path and the connection status of forwarding is as the normal path in blocking, wherein the CF is defined to be allowed to be forwarded; in forward, any frame is defined to be allowed to be forwarded. In the steps 103, 106 and 109, the predetermined time is decided by the designer, and the predetermined value is not intended for limiting the scope of the present invention.

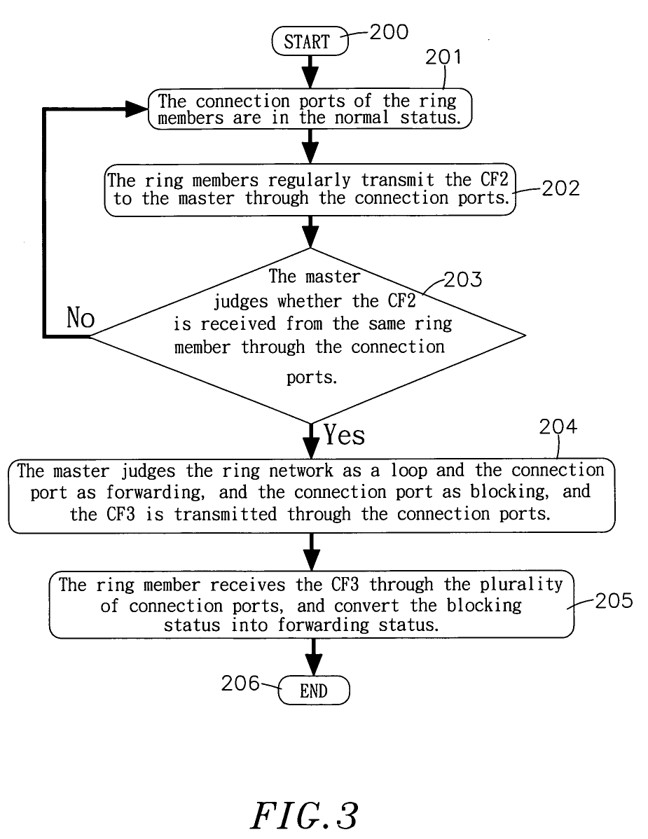

Referring to FIGS. 1 and 3, when the ring master election is finished and one of the second exchangers 2 is the master and the rest of the exchangers are the ring members, the connection status of the ring network remains the same, the loop checking will take place, and the procedure may be described as follows.

At step 200, the procedure is started.

At step 201, the connection ports 11, 12, 21 and 22 of the ring members are in the normal status.

At step 202, the ring members regularly transmit the CF2 to the master through the connection ports 11, 12, 21 and 22.

At step 203, the master judges whether the CF2 is received from the same ring member through the connection ports 21 and 22, wherein if it is judged that the CF2 is not received from the same ring member through the connection ports 21 and 22, the procedure returns to step 201, otherwise the procedure proceeds to step 204.

At step 204, the master judges the ring network as a loop and the connection port 21 as forwarding, and the connection port 22 as blocking, and the CF3 is transmitted through the connection ports 21 and 22.

At step 205, the ring member receives the CF3 through the plurality of connection ports, and converts the blocking status into forwarding status.

At step 206, the procedure is ended.

According to the above depiction, the CF2 comprises the ring member's own Mac address and the code of the transmitting connection port.

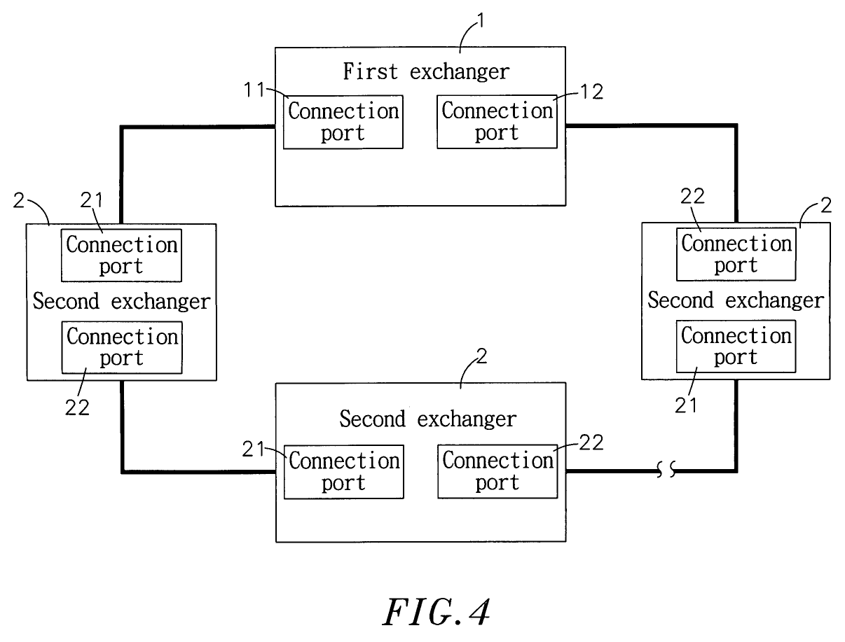

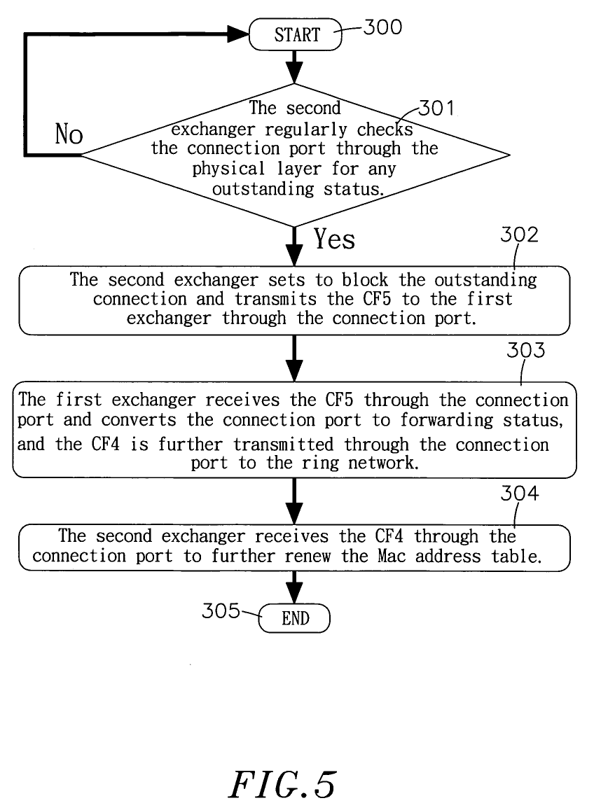

Referring to FIGS. 1, 4 and 5, after the ring master election is completed, if the first exchanger 1 is set as the master and the second exchanger 2 is as the ring member, the connection status of the connection port 11 of the first exchanger 1 is forwarding and the connection port 12 is blocking, the checking procedure may be described as follows.

At step 300, the procedure is started.

At step 301, the second exchanger 2 regularly checks the connection port 21 or 22 through the physical layer for any outstanding status, wherein if it is determined that there is no outstanding status, the procedure returns to step 300, otherwise the procedure proceeds to step 302.

At step 302, the second exchanger 2 sets to block the outstanding connection and transmits the CF5 to the first exchanger 1 through the connection port.

At step 303, the first exchanger 1 receives the CF5 through the connection port 11 or 12 and converts the connection port 12 to forwarding status, and the CF4 is further transmitted through the connection ports 11 and 12 to the ring network.

At step 304, the second exchanger 2 receives the CF4 through the connection port 21 or 22 to further renew the Mac address table.

At step 305, the procedure is ended.

When the first exchanger 1 transmits a CF4 to the ring network after receiving the CF5, and the second exchanger 2 is notified for renewing the path and the Mac address table. When the connection port 21 or 22 of the second exchanger 2 has outstanding situation, the second exchanger 2 continues to regularly check the connection status of the connection port during the period of the outstanding status. After the connection port 21 or 22 restores to normal status, the second exchanger 2 will regularly transmits the CF2 to the first exchanger 1 through the connection ports 21 and 22. If the first exchanger 1 receives the CF2 from the same second exchanger 2 through the connection port 11 or 12, one of the connection port will be set as blocking, and the CF4 will be sent through the connection port 11 or 12 in order to renew the Mac address table of the second exchanger 2.

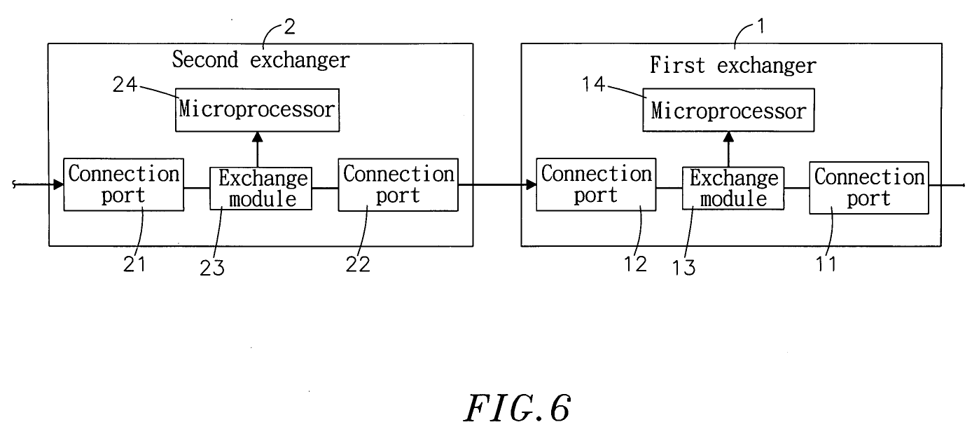

Referring to FIG. 6, the first exchanger 1 or the second exchanger 2 can transmit CF1, CF2, CF3, CF4 and CF5, when the above CFs are received by the connection ports 11, 12, 21 and 22 of the first or the second exchanger 1 or 2, the connection ports 11, 12, 21 and 22 will transmit the CF to the exchange modules 13 and 23 of the first exchanger 1 or the second exchanger 2, and the exchange modules 13, 23 will further transmit to the next first exchanger 1 or the second exchanger 2. Meanwhile, the CF will be duplicated for further transmission to microprocessors 14 and 24 of the first exchanger 1 or the second exchanger 2. According to the ring network structure in the preferred embodiment of the present invention, the number of the exchanger can be around 200 to 300 sets. The time to execute the redundancy mechanism can be less than 20 milliseconds (ms), and thus the backup mechanism can be promptly activated. However, the above preferred embodiment is not intended for limiting the scope of the present invention, the number of the exchanger can also be 1 to 100, 100 to 150, 300 to 500, and so on. The time to execute the redundancy mechanism can also be modified according to the number of the exchanger under the structure of the ring network.

The method for checking a ring network redundancy of the present invention has at least the following advantages.

1. The present invention has a plurality of ring members to transmit the CF to increase the reliability of checking the redundancy; when the ring network or the network traffic is overloaded, the master can judge whether to activate the backup path by the CF transmitted by the plurality of ring members, and thereby reduce the risk of losing the CF, as well as make the transmission of the ring network smoother.

2. The present invention uses the ring member to directly detect the connection status of the connection port through the physical layer; when the connection ports 11, 12, 21 and 22 have outstanding connection status, the CF5 can be sent directly to the master for learning the connection status of the connection port of the present ring member, and accordingly speed up the restoration of the ring network.

3. The present invention directly transmits through the exchange modules 13 and 23 of the first or the second exchanger 1 or 2 to the next first or second exchanger 1 or 2 to have more time to process the redundancy mechanism under the ring network structure with the plurality of exchangers, in order to promptly activate the backup function.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A method for checking a ring network redundancy, said ring network structure comprising a first exchanger and a plurality of second exchangers; said first exchanger comprising at least two connection ports, said second exchanger comprising at least two connection ports; wherein when said first exchanger is a master, said second exchanger are members, and said first exchanger comprises said connection port in a blocking connection status, and rest of said connection ports are in a forwarding status; said method comprising:
(A) starting;
(B) regularly checking said connection port through a physical layer for any outstanding status using said second exchanger; wherein if there is no outstanding status the procedure returns to step (A), otherwise the procedure proceeds to step (C);
(C) setting to block an outstanding connection and transmitting a CF5 to said first exchanger through said connection port using said second exchanger;
(D) receiving said CF5 through said connection port and converting said connection port to forwarding status using said first exchanger, and transmitting a CF4 through said connection port to said ring network;
(E) receiving said CF4 through said connection port using said second exchanger to further renew a Mac address table; and
(F) ending.

2. The method for checking a ring network redundancy according to claim 1, wherein a method for electing said master comprises:
(A1) predetermining said first exchanger and said second exchanger in said ring network both as said master;
(A2) defining a connecting status of said connection port in said first exchanger as blocking, and defining said connection port of said first exchanger and said connection ports of said second exchanger as forwarding;
(A3) transmitting said CF1 to said ring network through said connection ports using said first exchanger and said second exchanger;
(A4) judging whether said CF1 is received through said connection ports in a predetermined time using said first exchanger and said second exchanger, wherein if it is judged that said CF1 is not received through said connection ports in a predetermined time, the procedure returns to step (A3), otherwise the procedure proceeds to step (A5);
(A5) said first exchanger and said second exchanger respectively using its own predetermined value to compare with said CF1 in order to define said master and said ring member between said first exchanger and said second exchanger;
(A6) converting said second exchanger into said ring member if said first exchanger is judged as said master; and said second exchanger stops transmitting said CF1 to said ring member;
(A7) regularly transmitting said CF1 to said ring network through said connection port in said predetermined time using said first exchanger;
(A8) judging whether said first exchanger is said master using said second exchanger, wherein if it is judged that said first exchanger is said master, the procedure returns to step (A6), otherwise the procedure proceeds to step (A9);
(A9) converting into said master to transmit said CF1 to said ring network through said connection port using said plurality of second exchangers, wherein if not converted into said master, the procedure returns to step (A8), otherwise the procedure proceeds to step (A10); and
(A10) defining one of said second exchangers as said master according to said CF1 and predetermined value, and transmitting said CF1 to said ring network through said connection port; and rest of said second exchangers and said first exchanger are converted into said ring members, and said CF1 is stopped being transmitted thereby.

3. The method for checking a ring network redundancy according to claim 2, wherein said CF1 and said predetermined value respectively comprise a priority and a Mac address.

4. The method for checking a ring network redundancy according to claim 2, wherein said method of judges whether said master existed by said ring member comprises receiving said non CF1 transmitted by said first exchanger in a predetermined time, or said priority defined by a user has been changed.

5. The method for checking a ring network redundancy according to claim 2, wherein when a ring master election is completed and one of said second exchangers is said master and said rest of exchangers are said ring members, said connection status of said ring network remains the same, a loop checking procedure is commenced, which comprises:
(a) checking said connection ports of the ring members are in a normal status;
(b) regularly transmitting a CF2 to said master through said connection ports using said ring members;
(c) judging whether said CF2 is received from said same ring member through said connection ports using said master; wherein if it is judged that said CF2 is not received from said same ring member through said connection port, the procedure returns to step (a), otherwise the procedure proceeds to step (b);
(d) judging said ring network as said loop and determining said connection port as forwarding, and said connection port as blocking using said master, and transmitting a CF3 through said connection port; and
(e) receiving said CF3 through said plurality of connection ports using said ring member, and converting said blocking status into forwarding status;

6. The method for checking a ring network redundancy according to claim 1, wherein said first exchanger and said second exchanger are connected to a computer device, a work station or a server.

7. The method for checking a ring network redundancy according to claim 1, wherein when said connection port of said second exchanger comprises outstanding situation, said second exchanger continues to regularly check said connection status of said connection port during a period of said outstanding status; and after said connection port restores to normal status, said second exchanger regularly transmits said CF2 to said first exchanger through said connection port; wherein if said first exchanger receives said CF2 from said same second exchanger through said connection port, one of said connection ports is set as blocking, and said CF4 is sent through said connection port in order to renew said the Mac address table of said second exchanger.

8. The method for checking a ring network redundancy according to claim 1, wherein said first exchanger and said second exchanger respectively comprise exchange module and microprocessor, and said first exchanger and second exchanger transmit said CF1, CF2, CF3, CF4 and CF5 to each other through said connection port, wherein when said first exchanger and said second exchanger receives CFs, said CFs are further transmitted to said exchange module, and said exchange module transmits to said next first or second exchanger directly through said connection port, as well as to duplicate said CFs for further transmission to said microprocessor.
